(19) United States
(12) Patent Application Publication
(10) Pub. No.: US 2012/0313743 A1
(43) Pub. Date: Dec. 13, 2012

(54) LAMINATED ELECTRONIC COMPONENT EQUIPPED WITH INDUCTOR

(75) Inventors: Kazunari Kimura, Tokyo (JP); Shigemitsu Tomaki, Tokyo (JP); Misaki Tabata, Tokyo (JP); Isao Abe, Tokyo (JP)

(73) Assignee: TDK Corporation, Tokyo (JP)

(21) Appl. No.: 13/580,021

(22) PCT Filed: Sep. 7, 2011
(86) PCT No.: PCT/JP2011/070399

§ 371 Date: Aug. 20, 2012

(30) Foreign Application Priority Data
Sep. 9, 2010 (JP) 2010-201959

(51) Int. Cl. H01F 5/00

(52) U.S. Cl. 336/200

(57) ABSTRACT

A laminated electronic part comprises a first laminate, and a second laminate including a front wiring layer and bonded to the first laminate. Wiring layers of the first laminate and second laminate are orthogonal to each other. The first laminate has a first inductor conductor disposed on a first wiring layer, and a second inductor conductor disposed on a second wiring layer. The second laminate has a connection conductor for electrically connecting an end of the first inductor conductor with an end of the second inductor conductor on a surface thereof to which the first laminate is bonded, such that the first inductor conductor and the second inductor conductor form a coil-shaped inductor.

### TECHNICAL FIELD

The present invention relates to a laminated electronic parts including an inductor, and more particularly, to techniques for forming an inductor within a laminate without using a connection conductor, such as a throughhole, which extends through an insulating layer.

### BACKGROUND ART

Inductors are used for a variety of applications such as high-frequency LC filter circuit, resonator circuit, impedance matching, and the like. Also, for responding to requests for reduction in size and thickness and higher performance of electronic parts, inductors may be formed within a ceramic laminate to construct a variety of electronic parts and electronic modules.

FIGS. 28 and 29 show an example of a conventional inductor which is formed within such a laminate. When an inductor is formed of conductor patterns formed over a plurality of wiring layers, as shown in these figures, conductor patterns 2a, 2b, 2c, 2d, 2e, 2f, 2g formed on respective internal wiring layers of the laminate are conventionally connected by throughhole-type connection conductors V, such as throughholes, thereby forming an inductor having a spiral shape within the laminate. The conductor patterns 2a-2g on the respective wiring layers are formed, for example, by printing conductive paste on the surface of ceramic green sheets 1b-1h. Then, a plurality of these green sheets 1b-1h are laminated to create a laminate which is then singulated into chips which are eventually sintered to produce electronic parts.

Otherwise, the following patent documents disclose such laminated electronic parts including an inductor.

### PRIOR ART DOCUMENTS

### Patent Documents

Patent Document 1: JP-A-10-106838
Patent Document 2: JP-A-2009-170737

### SUMMARY OF THE INVENTION

Conventionally, for forming an inductor within a laminate, inductor conductors printed on respective wiring layers must be electrically interconnected by throughholes which extend through ceramic layers (green sheets) as shown in FIGS. 28 and 29 mentioned above and found in the patent documents. For this reason, the formation of the inductor cannot be concluded only in a printing process, but additionally requires processes for punching the throughholes through the ceramic layers, and filling a conductive paste within the holes, thus suffering from complicated manufacturing processes.

Also, a conventional coil-shaped inductor using throughholes comprises upper and lower conductor patterns which constitute the inductor, and throughholes for interconnecting them. Since the conductors for an inductor (pattern conductors) are discontinuous and include connections between the throughholes and the pattern conductors, this type of inductor is disadvantageous in providing for high Q and lower loss. As such, a desire exists for the provision of a new structure for an inductor which can be constructed only of conductor patterns without using throughholes for purposes of further improving the characteristics of electronic parts. Particularly, in recent years, electronic devices have been tremendously developed to provide more functions and higher functions, so that there is a need for implementing a high-Q and low-loss inductor which can support such electronic devices.

It is therefore an object of the present invention to enable an inductor to be formed over a plurality of layers within a laminate without using connection conductors which extend through insulating layers, such as throughholes, thereby simplifying the manufacturing process of laminated electronic parts including an inductor and further improving the electric characteristics of the same.

To solve the above problem and achieve the object, a first laminated electronic part according to the present invention comprises a first laminate having two or more wiring layers laminated through an insulating layer, and a second laminate having at least one insulating layer and a wiring layer formed on a surface of the insulating layer, and bonded to the first laminate, where the wiring layers in the first laminate and the wiring layers in the second laminate are substantially orthogonal to each other. The first laminate has a first inductor conductor disposed on a first wiring layer of the two or more wiring layers, and a second inductor conductor disposed on a second wiring layer of the two or more wiring layers, while the second laminate has a connection conductor for electrically connecting an end of the first inductor conductor with an end of the second inductor conductor on a surface of the second laminate to which the first laminate is bonded, such that the first inductor conductor and the second inductor conductor form a coil-shaped inductor.

In the laminated electronic part of the present invention, a coil-shaped inductor is created by electrically interconnecting a plurality of inductor conductors disposed on different wiring layers within a laminate (first laminate). However, instead of interconnecting the inductors by way of inter-layer connection conductors, such as throughholes, which extend through insulating layers, as has been conventionally done, the inductor conductors are interconnected by a second laminate which is bonded to the first laminate such that its wiring layer is substantially orthogonal to the wiring layers in the laminate (first laminate).

This second laminate comprises the wiring layer on a surface which serves to be bonded to the first laminate, and this wiring layer has been formed with the connection conductor (pattern conductor) for interconnecting the inductor conductors. Then, these first inductor conductor and second inductor conductor are electrically interconnected through the connection conductor by connecting an end of the first inductor conductor and an end of the second inductor conductor to the connection conductor.

The connection conductor disposed on the second laminate may be formed, for example, by such a method as printing a conductive paste. According to the present invention which has such a structure, the laminated electronic part can eliminate works for punching the throughholes through the ceramic layers, filling a conductive paste within the holes, and the like, which have been conventionally required. In addition, the inductor can be created only with conductor patterns formed on the surface of insulating layers, thus making it possible to contain a high-Q and low-loss inductor within the laminate.

In one aspect of the first laminated electronic part, the first laminate has the shape of rectangular parallelepiped as a whole, the first inductor conductor is formed on the first wiring layer in a loop shape, and has one end and the other end exposed to a surface of the first laminate to which the second laminate is bonded, the second inductor conductor is formed in a loop shape so as to substantially lie on the first inductor conductor on the second wiring layer, wherein the second inductor conductor has one end exposed to the surface of the first laminate to which the second laminate is bonded, and disposed at a position substantially matching with the one end of the first inductor conductor with respect to a direction in which the wiring layers are laminated in the first laminate (when viewed from a direction orthogonal to each wiring layer in the first laminate, which is applied to the following description as well), and the second inductor conductor has the other end exposed to the surface of the first laminate to which the second laminate is bonded, and disposed at a position substantially matching with the other end of the first inductor conductor, and the connection conductor electrically connects the other end of the first inductor conductor with the one end of the second inductor conductor.

Notably, in the electronic part described above, more inductor conductors can be provided in addition to the first inductor conductor and second inductor conductor, and a single inductor can be created as a whole by interconnecting these additional inductor conductors through connection conductors in a manner similar to the first inductor conductor and second inductor conductor (this is applied as well to a second through a fourth electronic part).

A second laminated electronic part of the present invention comprises a first laminate having four or more wiring layers laminated through an insulating layer and having the shape of rectangular parallelepiped as a whole; a second laminate including at least one insulating layer, and a wiring layer formed on a surface of the insulating layer, and bonded to the first laminate; and a third laminate including at least one insulating layer, and a wiring layer formed on a surface of the insulating layer, and bonded to the first laminate. Also, in this second laminated electronic part, the wiring layer on the second laminate and the wiring layer on the third laminate are both substantially orthogonal to the wiring layers in the first laminate. The first laminate includes a first bonding surface to which the second laminate is bonded, and a second bonding surface to which the third laminate is bonded, where the second bonding surface is opposite to or adjacent to the first bonding surface. The first laminate includes a first wiring layer, a second wiring layer, a third wiring layer, and a fourth wiring layer from above in order. The first laminate includes a first inductor conductor disposed on the first wiring layer; a second inductor conductor disposed on the second wiring layer; a third inductor conductor disposed on the third wiring layer; and a fourth inductor conductor disposed on the fourth wiring layer, where the first inductor conductor is formed on the first wiring layer in a loop shape, and has one end and the other end thereof both exposed to the first bonding surface, the second inductor conductor is formed on the second wiring layer in a loop shape such that the second inductor conductor substantially lies on the first inductor conductor, and has one end and the other end thereof both exposed to the second bonding surface, the third inductor conductor is formed on the third wiring layer in a loop shape such that the third inductor conductor substantially lies on the first inductor conductor and the second inductor conductor, the third inductor conductor has one end thereof exposed to the first bonding surface and disposed at a position substantially matching with one end of the first inductor conductor with respect to a direction in which the lamination is made in the first laminate, and the third inductor conductor has the other end exposed to the first bonding surface and disposed at a position substantially matching with the other end of the first inductor conductor with respect to the direction in which the lamination is made in the first laminate, and the fourth inductor conductor is formed on the fourth wiring layer in a loop shape such that the fourth inductor conductor substantially lies on the first inductor conductor, second inductor conductor, and third inductor conductor, and has one end thereof exposed to the second bonding surface and disposed at a position substantially matching with the one end of the second inductor conductor with respect to the direction in which the lamination is made in the first laminate, and the other end thereof exposed to the second bonding surface and disposed at a position substantially matching with the other end of the second inductor conductor with respect to the direction in which the lamination is made in the first laminate. The second laminate has a first connection conductor for electrically connecting the other end of the first inductor conductor with the one end of the third inductor conductor on the first bonding surface such that the first inductor conductor and third inductor conductor form a coil-shaped inductor. The third laminate includes a second connection conductor for electrically connecting the other end of the second inductor conductor with the one end of the fourth inductor conductor on the second bonding surface such that the second inductor conductor and fourth inductor conductor form a coil-shaped inductor.

According to the structure of the second laminated electronic part, a double-spiral inductor can be formed within the laminate. Specifically, a spiral inductor is formed of the first inductor conductor disposed on the first wiring layer and the third inductor conductor disposed on the third wiring layer in the first laminate, and another spiral inductor is formed of the second inductor conductor disposed on the second wiring layer and the fourth inductor conductor disposed on the fourth wiring layer. The lamination is made such that these spiral inductors lie one on another and are alternately interdigitated, when viewed in plan (in a direction in which the lamination is made in the first laminate, or in other words, when viewed from a direction orthogonal to each wiring layer in the first laminate). The first through fourth inductor conductors have the shape of loop, and are combined such that a spiral conductor formed of the first inductor conductor and third inductor conductor and a spiral conductor formed of the second inductor conductor and fourth inductor conductor are alternately interdigitated, thus forming a double-spiral loop as a whole.

Further, a third laminated electronic part of the present invention comprises a first laminate having three or more wiring layers laminated through an insulating layer and having the shape of rectangular parallelepiped as a whole; a second laminate including at least one insulating layer and a wiring layer formed on the at least one insulating layer, and bonded to the first laminate; and a third laminate including at least one insulating layer and a wiring layer formed on the at least one insulating layer, and bonded to the first laminate. Also, in this third laminated electronic part, the wiring layer on the second laminate and the wiring layer on the third laminate are both substantially orthogonal to the wiring layers in the first laminate. The first laminate includes a first bonding surface to which the second laminate is bonded, and a second bonding surface to which the third laminate is bonded, where the second bonding surface is opposite to the first bonding surface. When the first laminate includes a first wiring layer, a second wiring layer, and a third wiring layer labeled from above in order, the first laminate includes first inductor conductor having one end thereof exposed to the first bonding surface and the other end thereof exposed to the second bonding surface and formed on the first wiring layer such that the first inductor conductor extends from the first bonding surface to the second bonding surface; a second inductor conductor having one end thereof exposed to the first bonding surface and the other end thereof exposed to the second bonding surface and formed on the second wiring layer such that the second inductor conductor extends from the first bonding surface to the second bonding surface; and a third inductor conductor having one end thereof exposed to the first bonding surface and the other end thereof exposed to the second bonding surface and formed on the third wiring layer such that the third inductor conductor extends from the first bonding surface to the second bonding surface. The first inductor conductor and the third inductor conductor are disposed to substantially lie on the other when viewed in a direction in which the lamination is made in the first laminate, where the first inductor conductor and second inductor conductor are spaced apart from each other, and the third inductor conductor and second inductor conductor are spaced apart from each other when viewed in the direction in which the lamination is made in the first laminate. The second laminate has a first connection conductor for electrically connecting the one end of the first inductor conductor with the one end of the second inductor conductor on the first bonding surface such that the first inductor conductor and the second inductor conductor form a coil-shaped inductor. The third laminate includes a second connection conductor for electrically connecting the other end of the second inductor conductor with the other end of the third inductor conductor on the second bonding surface such that the second inductor conductor and the third inductor conductor form a coil-shaped inductor.

In this third laminated electronic part, each inductor conductor can be typically a linear (rectangular or strip) electrode which extends between the first bonding surface and the second bonding surface, but otherwise, the inductor conductors may vary in shape, and may take, for example, a bent shape, a curving shape, and the like.

Further, a fourth laminated electronic part of the present invention comprises a first laminate having two or more wiring layers laminated through an insulating layer and having the shape of rectangular parallelepiped as a whole; a second laminate having two or more wiring layers laminated through an insulating layer and having the shape of rectangular parallelepiped as a whole; and a third laminate having a front wiring layer formed on a front surface thereof and a back wiring layer formed on a back surface thereof and interposed between the first laminate and the second laminate, where the third laminate is bonded to the first laminate and to the second laminate, such that the front wiring layer is in contact with the first laminate and the back wiring layer is in contact with the second laminate. The front wiring layer on the third laminate is substantially orthogonal to the wiring layers in the first laminate, and the back wiring layer on the third laminate is substantially orthogonal to the wiring layers in the second laminate. Also, in this fourth laminated electronic part, the first laminate includes a first inductor conductor disposed on a first wiring layer of the two or more wiring layers in the first laminate, and a second inductor conductor disposed on a second wiring layer of the two or more wiring layers in the first laminate, while the second laminate has a third inductor conductor disposed on a first wiring layer of the two or more wiring layers in the second laminate, and a fourth inductor conductor disposed on a second wiring layer of the two or more wiring layers in the second laminate. Also, the third laminate includes a first connection conductor on the front wiring layer for electrically connecting an end of the first inductor conductor with an end of the second inductor conductor on a surface of the third laminate to which the first laminate is bonded, such that the first inductor conductor and second inductor conductor form a coil-shaped inductor, and a second connection conductor on the back wiring layer for electrically connecting an end of the third inductor conductor with an end of the fourth inductor conductor on a surface of the third laminate to which the second laminate is bonded, such that the third inductor conductor and fourth inductor conductor form a coil-shaped inductor.

Alternatively, in this fourth electronic part, the inductor conductors (first inductor conductor, second inductor conductor, third inductor conductor, and fourth inductor conductor) may have the shape of loop as in the one aspect of the first laminated electronic part, or may be linear electrodes (extending from one to the other of opposing surfaces of the laminate), as described in the third electronic part). Also, when the inductor conductor is formed of such linear electrode, an additional laminate including a connection conductor may be bonded to each of the first laminate and second laminate on the surface opposite to the one to which the third laminate is bonded (surface opposing the bonding surface), and ends of the inductor conductors may be electrically interconnected on the opposing surface (surface opposite to the bonding surface to which the third laminate is bonded).

In each of the electronic parts according to the present invention, the laminate including inductor conductors can be formed by laminating, for example, ceramic green sheets. The inductor conductors and connection conductors can be formed, for example, by a printing method (for example, screen printing).

On the other hand, a laminate which comprises a connection conductor, and is bonded to a laminate which includes inductor conductors, specifically, the second laminate in the first laminated electronic part, the second laminate and third laminate in the second and third laminated electronic parts, and the third laminate in the fourth laminated electronic part, can be typically created by a laminar structure which comprises a wiring layer on one or both of the front surface and back surface, as will be later described. However, the present invention is not limited to such a structure, but can internally comprise a wiring layer, similar to the laminate including the inductor conductor, by way of example, or can comprise circuit elements and conductor patterns on the internal wiring layer, other than the connection conductor, as referred to in the present invention.

Further, the laminate including the inductor conductors can be bonded with the laminate comprising the connection conductor, for example, by thermocompression bonding both laminates made of ceramic green sheets, while heating them, for integration, and subsequently sintering the resulting product. With this sintering, both laminates are firmly bonded, resulting in a continuous sintered body. For reference, a previous proposition by the Applicant (Japanese Patent Application No. 2010-165398) can be preferably applied to the manufacturing of an electronic part according to the present invention which includes a bonding process. This manufacturing method will be described later in greater details in Description of Embodiment with reference to the accompanying drawings.

Also, the “laminated electronic part,” referred to in the present invention, may be a discrete part solely comprising an inductor (chip inductor), but may also be a composite electronic part which includes a variety of circuit elements other than the inductor, such as other passive elements such as a capacitor, a resistor, and the like, or active elements such as a transistor and FET, an integrated circuit including active elements, such as IC, and the like.

Also, when the laminated electronic part, as referred to in the present invention, is considered from a functional aspect (type of parts), a variety of electronic parts and electronic modules are encompassed in the laminated electronic part as referred to in the present invention, for example, filters such as a bandpass filter, a low pass filter, and high pass filter, a duplexer, a diplexer, a power amplifier module, a high-frequency multiplexer module, an isolator, a sensor, and the like.

It should be noted that the present invention does not prohibit a through-type connection conductor which extends through an insulating layer from being included in the electronic part according to the present invention, but may include a through-type connection conductor, for example, for use in connection with an external terminal, another circuit element, and the like.

### EFFECTS OF THE INVENTION

According to the present invention, a coil-shaped inductor can be formed over a plurality of layers within a laminate without using a through-type connection conductor which extends through an insulating layer, such as a throughhole, thus making it possible to simplify the process of manufacturing a laminated electronic part including a coil-shaped inductor, and improving the electronic characteristics of the electronic part.

Other objects, features, and advantages of the present invention will be made apparent from the following description of embodiments of the present invention, made in conjunction of the drawings. It should be apparent to those skilled in the art that the present invention is not limited to the following embodiments, but a variety of modifications can be made within the scope of the invention defined by the appended claims. In the following description of embodiments, the same or comparable elements are designated by the same reference numerals.

### BRIEF DESCRIPTION OF THE DRAWINGS

FIG. 1 is a perspective view showing an appearance of a laminated inductor according to a first embodiment of the present invention.

FIG. 2 is a perspective view showing conductor patterns of the laminated inductor according to the first embodiment.

FIG. 3 is an exploded perspective view of the laminated inductor according to the first embodiment.

FIG. 4 is a perspective view showing an appearance of a laminated inductor according to a second embodiment of the present invention.

FIG. 5 is a perspective view showing conductor patterns of the laminated inductor according to the second embodiment.

FIG. 6 is an exploded perspective view of the laminated inductor according to the second embodiment.

FIG. 7 is a perspective view showing the internal structure of a laminated inductor according to a third embodiment of the present invention in a see-through form.

FIG. 8 is an exploded perspective view of the laminated inductor according to the third embodiment.

FIG. 9 is a graph representing the Q-value of the laminated inductor according to the third embodiment in comparison with that of a conventional laminated inductor.

FIG. 10 is an equivalent circuit diagram of a laminated bandpass filter according to a fourth embodiment of the present invention.

FIG. 11 is a perspective view showing the internal structure of the laminated bandpass filter according to the fourth embodiment in a see-through form.

FIG. 12 is an exploded perspective view of the laminated bandpass filter according to the fourth embodiment.

FIG. 13 is a graph representing the frequency characteristic of the laminated bandpass filter according to the fourth embodiment.

FIG. 14 is a perspective view schematically showing a step of a manufacturing method suitable for manufacturing a laminated electronic part according to the present invention.

FIG. 15 is a perspective view schematically showing a step in the manufacturing method.

FIG. 16 is a perspective view schematically showing a step in the manufacturing method.

FIG. 17 is a perspective view schematically showing a step in the manufacturing method.

FIG. 18 is a perspective view schematically showing a step in the manufacturing method.

FIG. 19 is a perspective view schematically showing a step in the manufacturing method.

FIG. 20 is a perspective view schematically showing a step in the manufacturing method.

FIG. 21 is a perspective view schematically showing a step in the manufacturing method.

FIG. 22 is a perspective view schematically showing a step in the manufacturing method.

FIG. 23 is a perspective view schematically showing a step in the manufacturing method.

FIG. 24 is a perspective view schematically showing a step in the manufacturing method.

FIG. 25 is a diagram schematically showing a cross-section (taken along B-B in FIG. 24)of a reorganized laminated sheets in the manufacturing method.

FIG. 26 is a perspective view schematically showing a step in the manufacturing method.

FIG. 27 is a perspective view schematically showing a step in the manufacturing method.

FIG. 28 is a perspective view showing the internal structure of a conventional laminated inductor in a see-through form.

FIG. 29 is an exploded perspective view of the conventional laminated inductor.

### BEST MODE FOR CARRYING OUT THE INVENTION

### First Embodiment

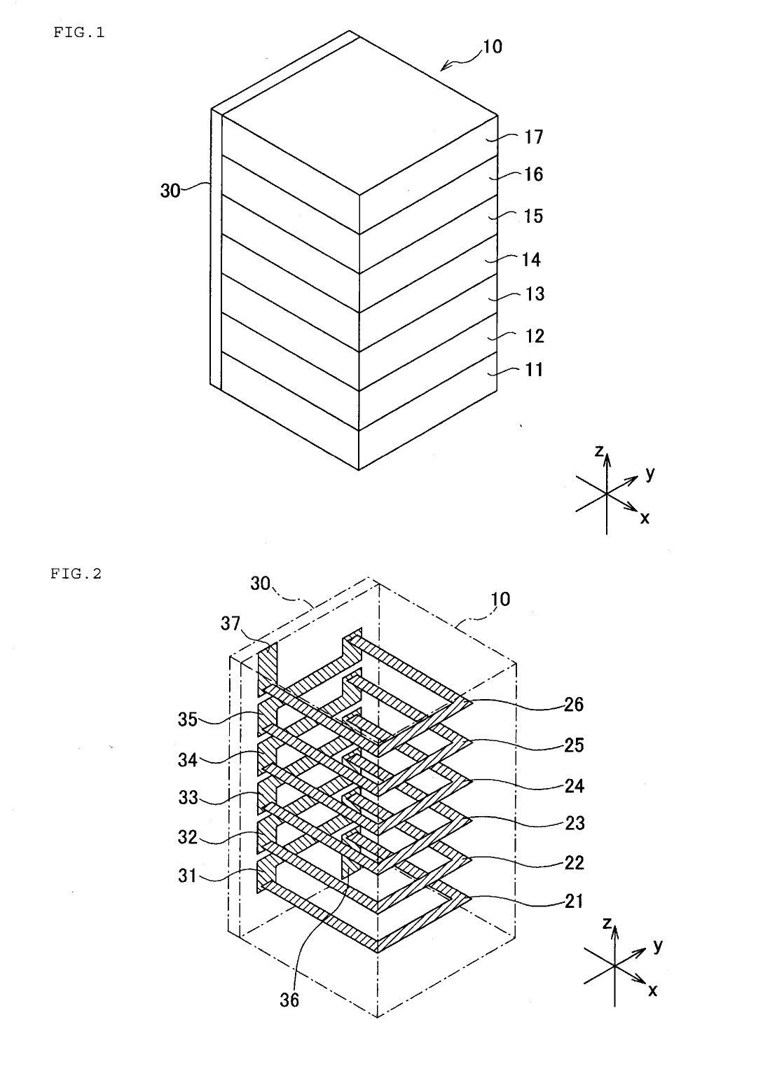

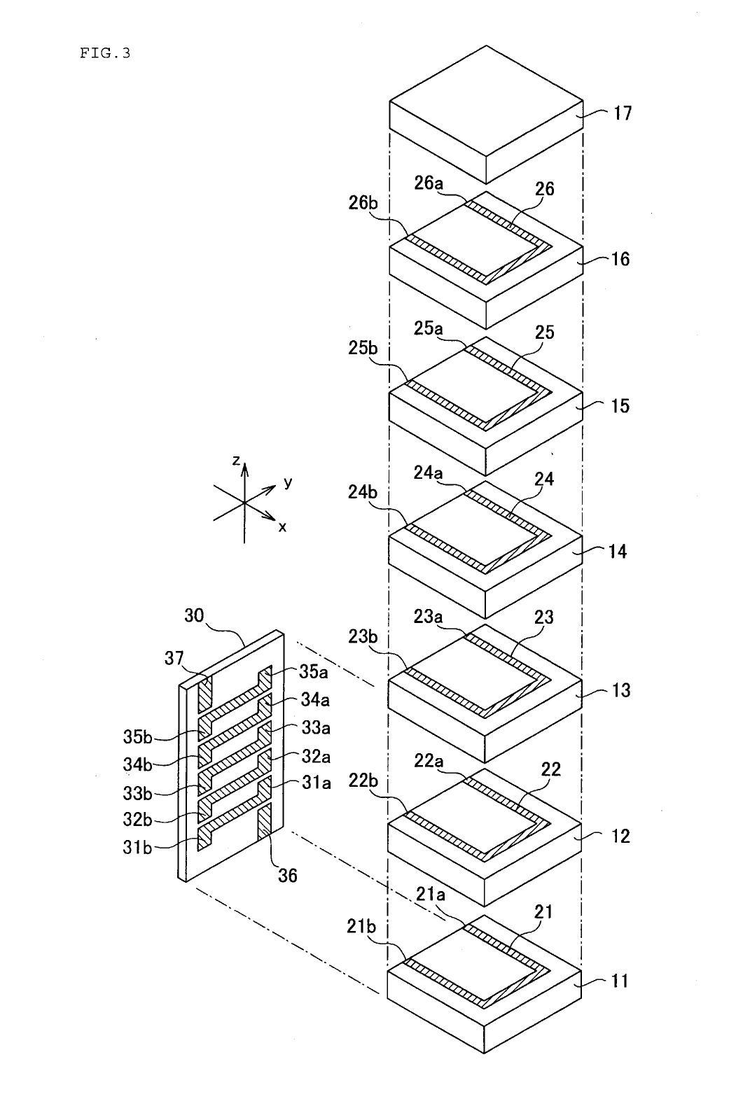

As shown in FIGS. 1-3, an electronic part according to a first embodiment of the present invention comprises a first laminate 10 made up of ceramic sheets 11, 12, 13, 14, 15, 16, 17 which are laminated to include a plurality (six in the illustrated example) of internal wiring layers, and a second laminate 30 which includes a ceramic sheet and a wiring layer formed on the surface of the ceramic sheet. The first laminate 10 is bonded to the second laminate 30 such that their components are laminated in directions orthogonal to each other (the wiring layers of the first laminate 10 are placed at angle of 90° to the wiring layer of the second laminate 30).

Each of the internal wiring layers in the first laminate 10 is formed with an inductor conductor 21, 22, 23, 24, 25, 26, which is substantially in a C-shape (substantially in a U-shape), when viewed in plan. These inductor conductors 21-26 formed on the respective wiring layers are arranged to exactly lie one on another, when viewed in plan (when viewed from the z-axis direction in FIGS. 1 through 3). Also, these inductor conductors 21-26 have their both ends (one end 21a-26a and the other end 21b-26b) exposed to a side surface of the first laminate 10 to which the second laminate 30 is bonded, such that they can be electrically connected with connection conductors provided on the second laminate 30.

In the following description, the internal wiring layers in the first laminate 10 are referred to from the bottom as a first layer, a second layer, . . . , in order, and the topmost internal wiring layer as a sixth layer. Also, the inductor conductor 21 formed on the first layer is referred to as a first inductor conductor; the inductor conductor 22 formed on the second layer as a second inductor conductor; and the inductor conductors 23-26 formed respectively on the third through sixth layers as a third inductor conductor, a fourth inductor conductor, a fifth inductor conductor, and sixth inductor conductor, respectively (similar designation is applied as well to embodiments later described). As will be appreciated, the number of laminated layers (number of inductor conductors) is not particularly limited to this example (six layers or six), and more or less layers may be laminated.

On a surface wiring layer of the second laminate 30, a plurality of connection conductors 31, 32, 33, 34, 35 are formed for electrically interconnecting the inductor conductors 21-26 such that the first through sixth inductor conductors, as a whole, functions as an inductor.

Specifically, the first connection conductor 31 has one end 31a, which is to be brought into contact with one end 22a of the second inductor conductor 22, exposed on the side surface of the first laminate 10, and the other end 31b which is to be brought into contact with the other end 21b of the first inductor conductor 21. This first connection conductor 31 is formed on the surface of the second laminate 30 which is to be bonded with the first laminate 10. Through this first connection conductor 31, the first inductor conductor is electrically connected with the second inductor conductor 22.

Similarly, the second connection conductor 32 has one end 32a, which is to be brought into contact with one end 23a of the third inductor conductor 23, exposed on the side surface of the first laminate 10, and the other end 32b which is to be brought into contact with the other end 22b of the second inductor conductor 22. The second connection conductor 32 is formed on the surface of the second laminate 30. Through this second conductor 32, the second inductor conductor 22 is electrically connected with the third inductor conductor 23. Subsequently, with similarly formed third connection conductor 33, fourth conductor 34, and fifth connection conductor 35, the third inductor conductor 23 through sixth inductor conductor 26 are connected one by one in order to form an inductor such that the first through sixth inductor conductors 21-26 become spiral in shape within the first laminate 10.

In this regard, the first laminate 10 may be provided on its top and bottom with terminal electrodes (not shown) for external connections, or with additional laminated ceramic sheets which may be formed with wiring layers to create another circuit element. For connecting these terminal electrodes and/or other circuit element with the inductor, connection conductors 36, 37 may be disposed in an upper end area and a lower end area, respectively, on the surface of the second laminate 30, in a manner similar to the aforementioned connection conductors, such that the terminal electrodes and other circuit element may be connected with the inductor through these connection conductors 36, 37.

### Second Embodiment

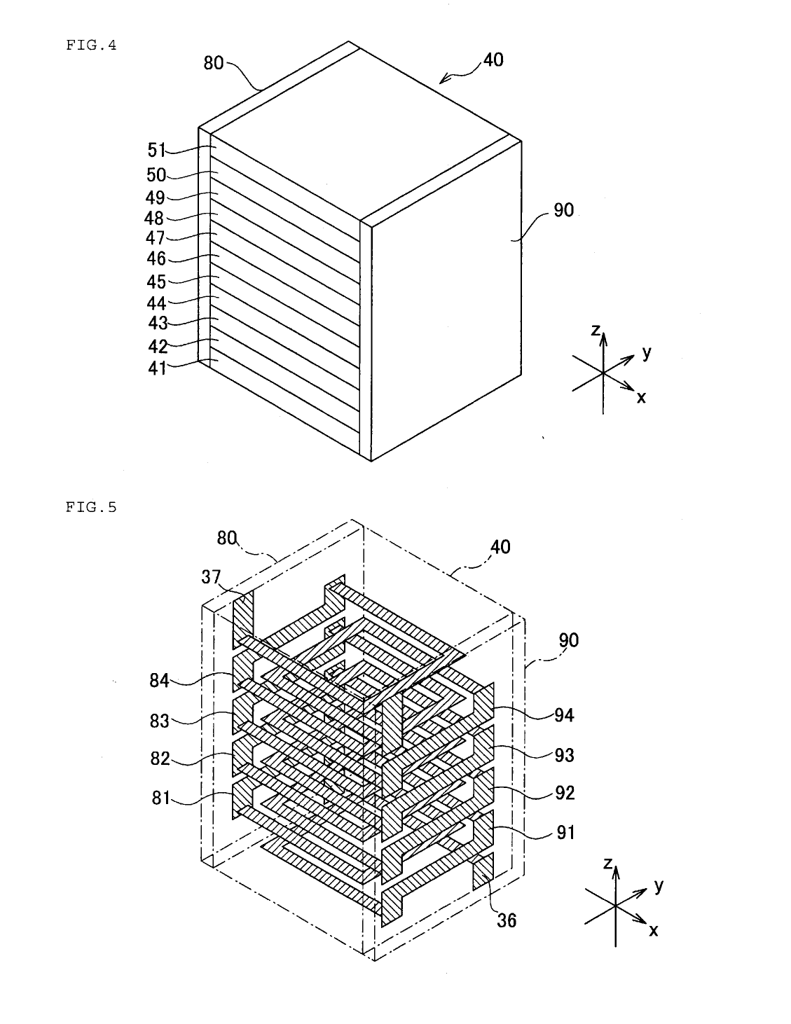

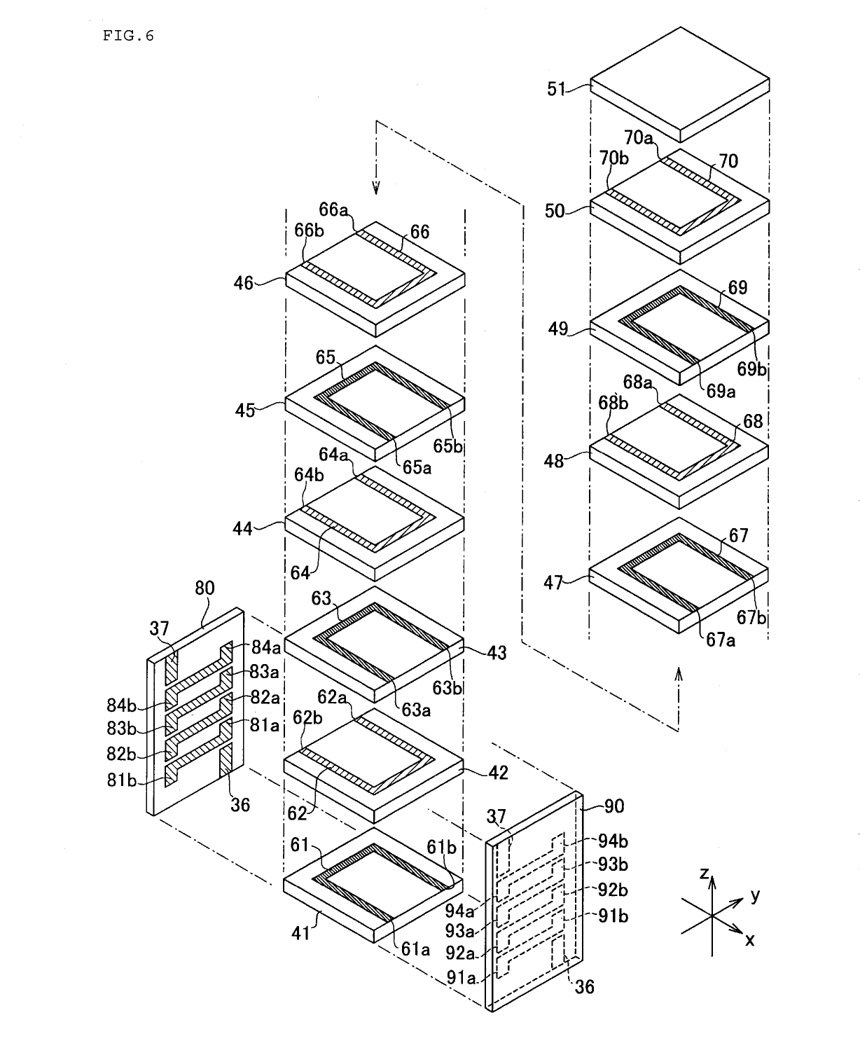

An electronic part according to a second embodiment of the present invention, similar to the inductor of the first embodiment, comprises a first laminate which includes an inductor conductor on each wiring layer in the ceramic laminate; and laminates, each of which includes connection conductors for interconnecting these inductor conductors so as to form an inductor. However, unlike the first embodiment, a second laminate 80 and a third laminate 90 are bonded on a pair of opposing side surfaces of the first laminate 40, such that the inductor has a double spiral structure, as shown in FIGS. 4 through 6.

Specifically, each wiring layer of the first laminate 40 includes an inductor conductor 61-70 in substantially C-shape (substantially U-shape), when viewed in plan, in a manner similar to the first embodiment, however, these inductor conductors 61-70 are laminated such that they are alternately oriented in reverse directions. More specifically, the second inductor conductor 62 formed on a second layer of the internal wiring layers, the fourth inductor conductor 64 formed on a fourth layer, the sixth inductor conductor 66 formed on a sixth layer, the eighth inductor conductor 68 formed on the eighth layer, and the tenth inductor conductor 70 formed on a tenth layer (hereinafter they are referred to as the “even-numbered layer inductor conductors” which are also used in a third embodiment, later described) are disposed such that their both ends expose to a side surface (first bonding surface) of the first laminate 40 which serves as a bonding surface with the second laminate 80, as seen in the first embodiment.

On the other hand, the first inductor conductor 61 formed on a first layer, the third inductor conductor 63 formed on a third layer, the fifth inductor conductor 65 formed on a fifth layer, the seventh inductor 67 formed on a seventh layer, and the ninth inductor conductor 69 formed on a ninth layer (hereinafter they are referred to as the “odd-numbered layer inductor conductors” which are also used in a third embodiment, later described) are disposed in reverse orientation (rotated by 180° in a horizontal plane or an x-y plane) such that their both ends expose to the side surface (second bonding surface) opposite to the aforementioned side surface (first bonding surface). Then, the third laminate 90 is bonded to this opposing side surface (second bonding surface).

Also, the first through tenth inductor conductors 61-70 are disposed to lie one on another, when viewed in plan, except for those ends which are to be connected to the connection conductors 81-84, 91-94, where an inductor formed of the odd-numbered layer inductor conductors 61, 63, 65, 67, 69 and an inductor formed of the even-numbered layer inductor conductors 62, 64, 66, 68, 70 constitute a single inductor, as a whole, in the shape of double spiral. The second laminate 80 and third laminate 90 comprise connection conductors 81-84, 91-94 similar to those in the first embodiment, on their surfaces (to which the first laminate 40 is to be bonded), respectively. Through these connection conductors, the respective inductor conductors 61-70 in the first laminate 40 are interconnected to form the respective spiral inductors.

As appreciated, in this embodiment, the opposing side surfaces of the first laminate 40 are chosen to be the surfaces to which the second laminate 80 and third laminate 90 are bonded, but alternatively, adjacent side surfaces may be chosen instead to provide an inductor in double spiral structure as well. In this event, the odd-numbered layer inductor conductors 61, 63, 65, 67, 69 and the even-numbered layer inductor conductors 62, 64, 66, 68, 70 may be disposed such that they form an angle of 90° to each other, when viewed in plan. Further, when this embodiment is applied, an inductor can be created in a treble or a quadruple spiral structure as well.

### Third Embodiment

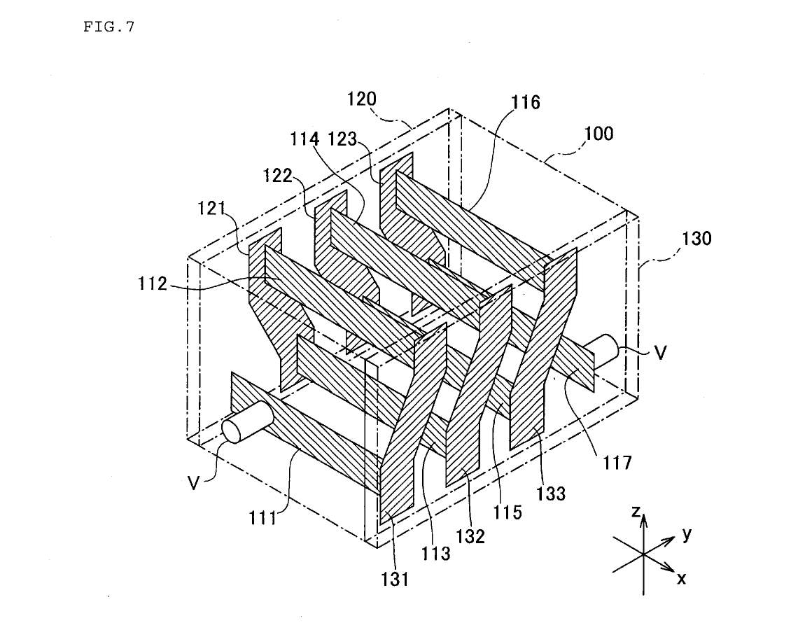

As shown in FIGS. 7 and 8, an electronic device according to a third embodiment of the present invention comprises a first laminate 100 which includes inductor conductors 111, 112, 113, 114, 115, 116, 117 disposed on respective wiring layers of a ceramic laminate, and laminates (second laminate 120 and third laminate 130) which include connection conductors 121, 122, 123, 131, 132, 133 for interconnecting these inductor conductors 111-117, in a manner similar to the first and second embodiments. However, unlike the previous embodiments, each inductor conductor 111-117 is a linear electrode which extends across a pair of opposing side surfaces of the first laminate 100, and these electrodes are interconnected through the connection conductors 121-123 disposed on the second laminate 120 and the connection conductors 131-133 disposed on the third laminate 130 so as to form an inductor.

More specifically, the first laminate 100 is created by laminating ceramic sheets 101-109 in the front-back direction (y-axis direction). Then, the second laminate 120 is bonded to one side surface (first bonding surface) of the first laminate 100 such that the wiring layers in the first laminate 100 are orthogonal to the wiring layer on the second laminate 120, while the third laminate 130 is bonded to the other side surface (second bonding surface) of the first laminate 100 such that the wiring layers of the first laminate 100 are orthogonal to the wiring layer on the third laminate 130.

The first through seventh internal wiring layers of the first laminate 100 are formed with strip-shaped inductor electrodes (first through seventh inductor conductors) 111-117, respectively, each of which has one end exposed to the first bonding surface and the other end exposed to the second bonding surface. Notably, among these inductor conductors 111-117, those formed on the odd-numbered layers, i.e., the first inductor conductor 111 formed on the first layer, the third inductor conductor 113 formed on the third layer, the fifth inductor conductor 115 formed on the fifth layer, and the seventh inductor conductor 117 formed on the seventh layer, are formed to extend horizontally in a lower area of the respective layering layer near the bottom of the first laminate 100.

On the other hand, the inductor conductors formed on the even-numbered layers, i.e., the second inductor conductor 112 formed on the second layer, the fourth inductor conductor 114 formed on the fourth layer, and the sixth inductor conductor 116 formed on the sixth layer are formed to extend horizontally in an upper area of the respective wiring layers near the top of the first laminate 100.

Also, when the first laminate 100 is viewed from the front (from the direction in which the ceramic sheets 101-109 are laminated, or in the y-axis direction), the odd-numbered layer inductor conductors (first inductor conductor 111, third inductor conductor 113, fifth inductor conductor 115, and seventh inductor conductor 117) lie one on another, and the even-numbered inductor conductors (second inductor conductor 112, fourth inductor conductor 114, and sixth inductor conductor 116) lie one on another. Further, when viewed from the front, these odd-numbered layer inductor conductors 111, 113, 115, 117 and even-numbered layer inductor conductors 112, 114, 116 are disposed such that they extend in parallel and horizontally and are spaced apart from one another by a certain interval.

Then, on the first bonding surface, one end 112a of the second inductor conductor 112 is connected with one end 113a of the third inductor conductor 113 through the connection inductor 121 disposed on the surface of the second laminate 120; one end 114a of the fourth inductor conductor 114 is connected with one end 115a of the fifth inductor conductor 115 through the connection conductor 122 disposed on the surface of the second laminate 120; and one end 116a of the sixth inductor conductor 116 is connected with the one end 117a of the seventh inductor conductor 117 through the connection conductor 123 disposed on the surface of the second laminate 120.

Similarly, on the second bonding surface, the other end 111b of the first inductor conductor 111 is connected with the other end 112b of the second inductor conductor 112 through the connection conductor 131 disposed on the surface of the third laminate 130; the other end 113b of the third inductor conductor 113 is connected with the other end 114b of the fourth inductor conductor 114 through the connection conductor 132 disposed on the surface of the third laminate 130; and the other end 115b of the fifth inductor conductor 115 is connected with the other end 116b of the sixth inductor conductor 116 through the connection conductor 133 disposed on the surface of the third laminate 130.

In this way, the first inductor conductor through seventh inductor conductor are electrically interconnected in order, thus allowing the formation of a spiral inductor which extends within the first laminate in the laminating direction (front-to-back direction or y-axis direction).

Notably, the first laminate 100 can be provided with terminal electrodes (not shown) for external connection on the front and back surfaces. The front surface of the first laminate 100 is formed with a throughhole V for connecting the terminal electrode on the front surface with the one end 111a of the first inductor conductor 111, while the back surface of the first laminate 100 is formed with a throughhole V for connecting the terminal electrode on the back surface with the other end 117b of the seventh inductor conductor 117. However, these connections may be alternatively made through the connection conductors disposed respectively on the surface of the second laminate 120 and on the surface of the third laminate 130 in a manner similar to the second embodiment.

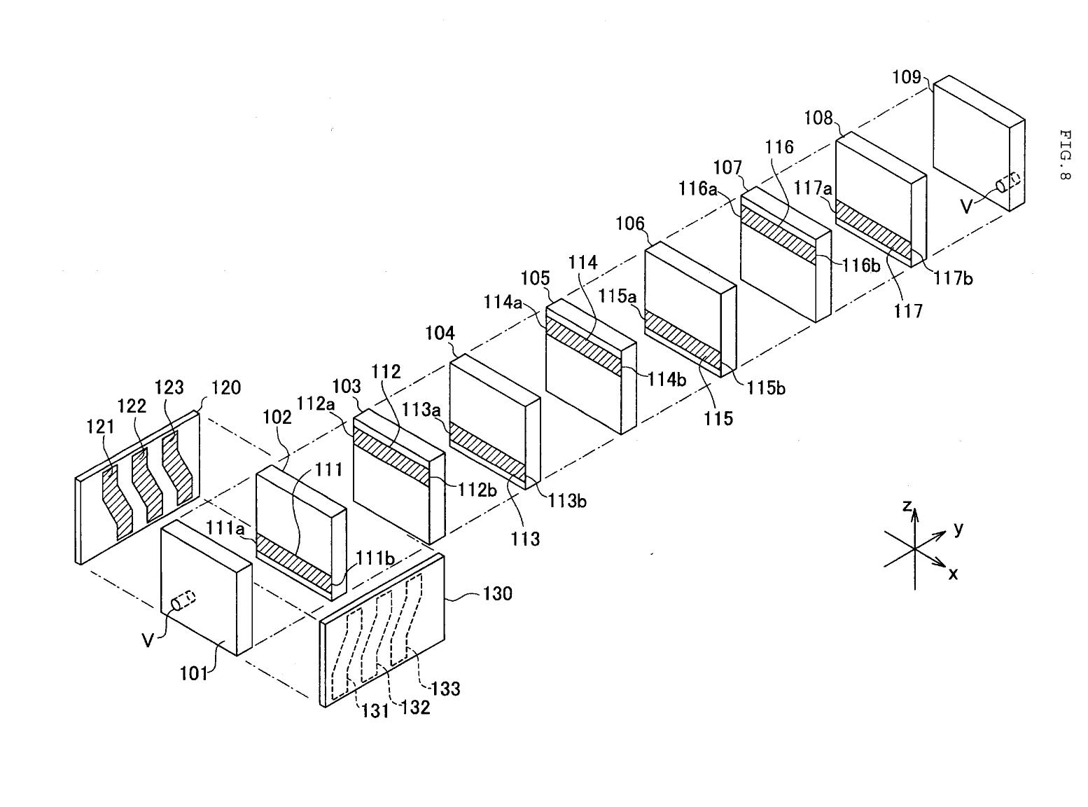

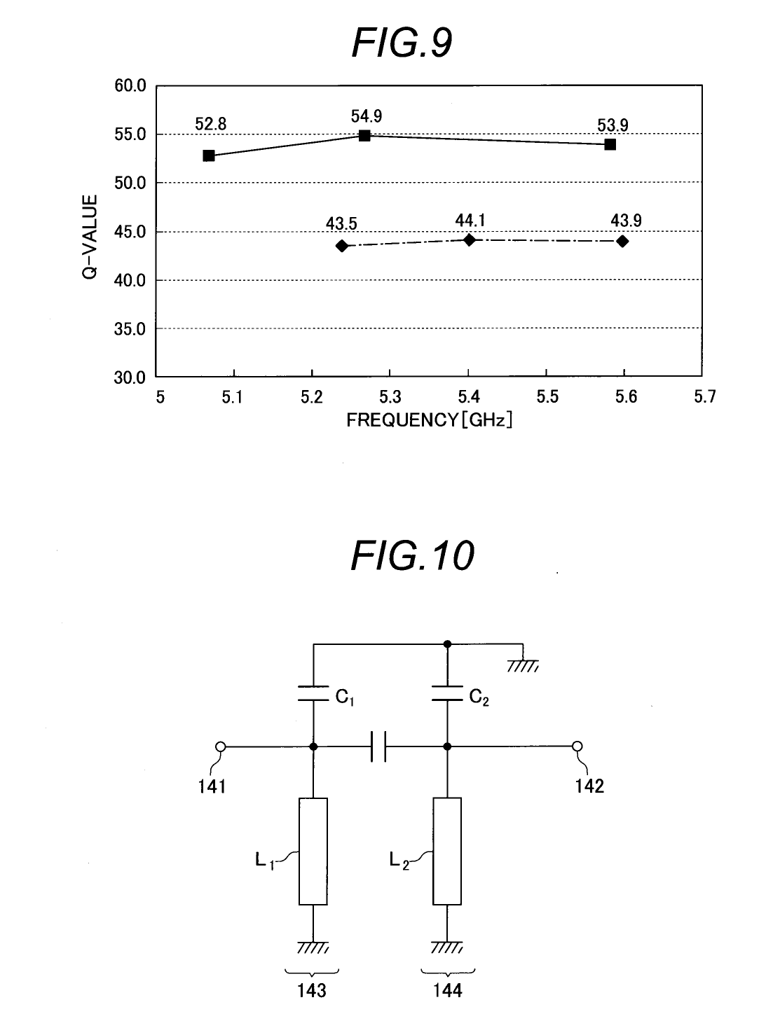

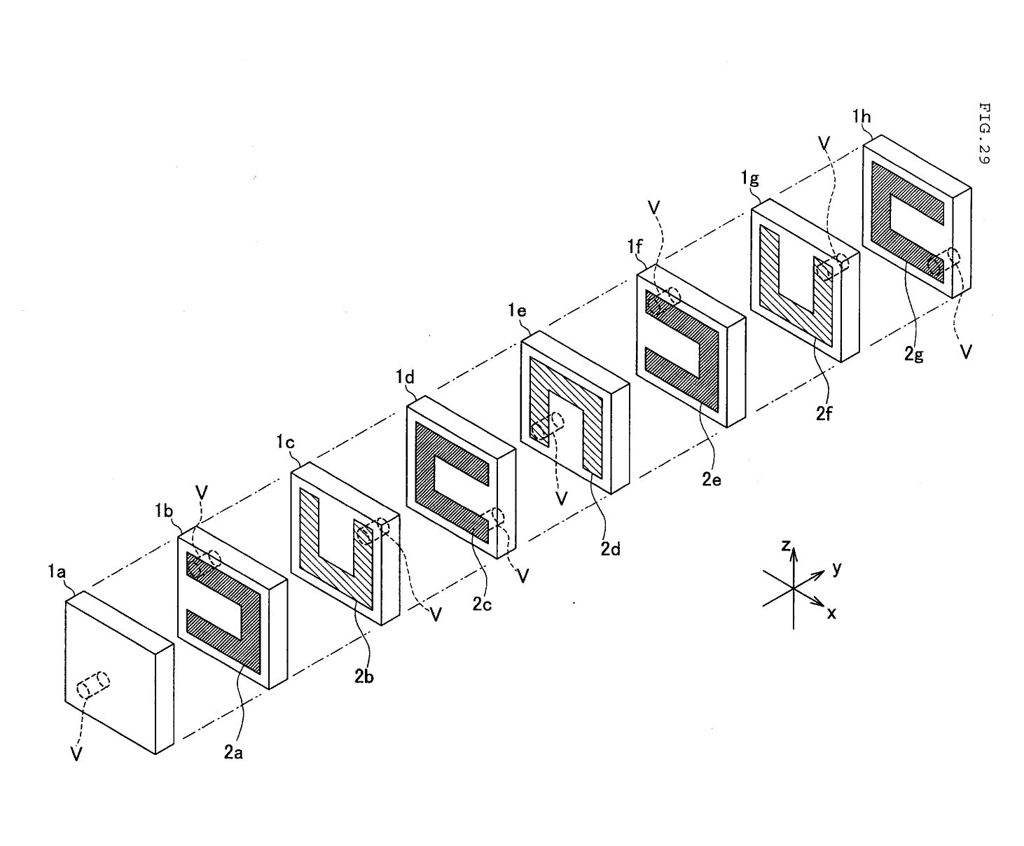

FIG. 9 shows the Q-value of the inductor of this embodiment in comparison with the Q-value of the conventional inductor shown in FIGS. 28 and 29. In the graph, a solid line represents the Q-value of the inductor of this embodiment, and a one-dot chain line represents that of the conventional structure. As is apparent from this graph, it is understood that, according to this embodiment, a higher Q-value can be provided than the conventional structure of the inductor which is formed using throughholes.

### Fourth Embodiment

As shown in FIG. 10, an electronic part according to a fourth embodiment of the present invention, is a bandpass filter which comprises two resonators, i.e., an LC resonator 143 made up of an inductor L1 and a capacitor C1, and an LC resonator 144 made up of an inductor L2 and a capacitor C2, between input/output terminals 141, 142, thereby forming a pass band.

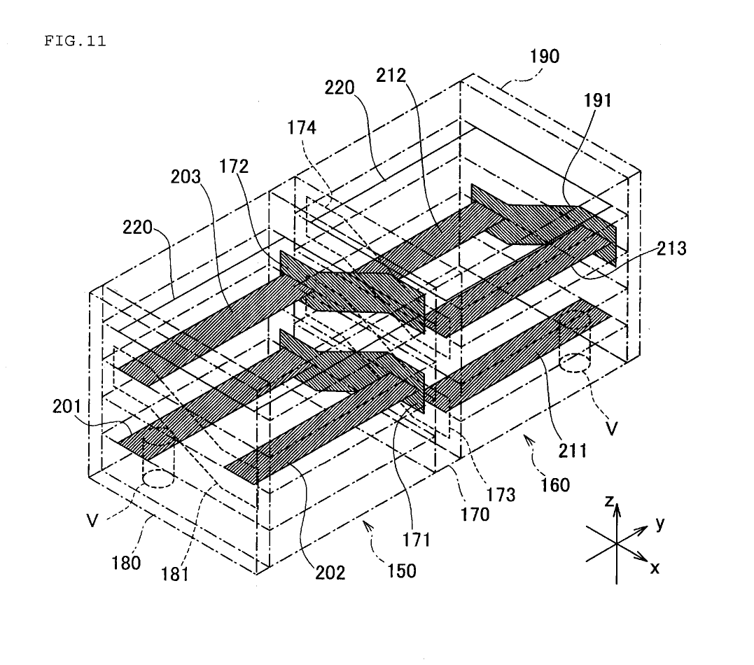

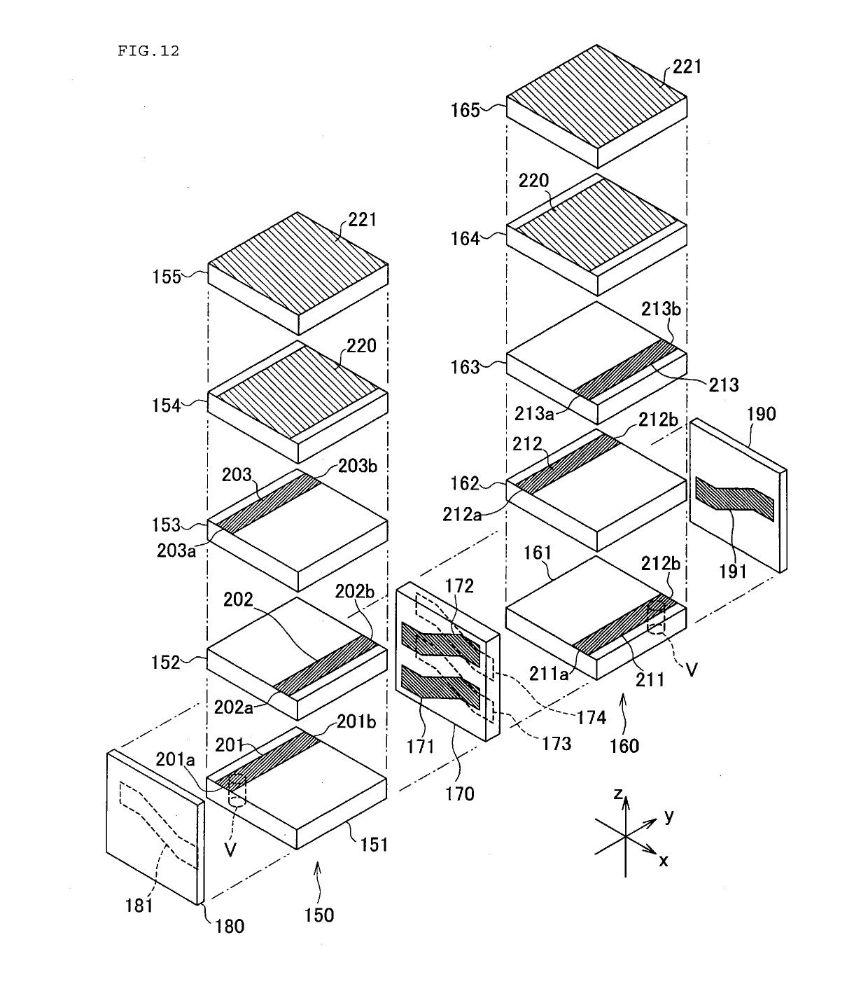

In regard to the laminate structure, as shown in FIGS. 11 and 12, the electronic part comprises a first laminate 150 which contains the first-stage resonator (first resonator) 143; a second laminate 160 which contains the second-stage resonator (second resonator) 144; a third laminate 170 which is bonded to the back surface of the first laminate 150 and to the front surface of the second laminate 160 such that it intervenes between these laminates 150 and 160; a fourth laminate 180 bonded to the surface (front surface) of the first laminate 150 opposite to the surface to which the third laminate 170 is bonded (on the opposite side); and a fifth laminate 190 bonded to the surface (back surface) of the second laminate 160 opposite to the surface to which the third laminate 170 is bonded (on the opposite side).

Also, the wiring layers in the first laminate 150 are in parallel with the wiring layers in the second laminate 160, while the wiring layers on the third laminate 170, fourth laminate 180, and fifth laminate 190 are in parallel with one another. Also, the respective wiring layers in the first laminate 150 and second laminate 160 are orthogonal to the respective wiring layers on the fourth laminate 180 and fifth laminate 190.

Describing specifically the laminate structure of this filter in greater details, the first laminate 150 and second laminate 160 are each a ceramic laminate which has five ceramic sheets 151, 152, 153, 154, 155; or 161, 162, 163, 164, 165 laminated in the vertical direction (z-axis direction) such that four internal wiring layers are included therein. The fourth laminate 180 and fifth laminate 190 comprise connection conductors disposed on the surface thereof in a manner similar to the second laminate 120 and third laminate 130 in the third embodiment. The third laminate 170 comprises the connection conductors 171, 172; 173, 174 disposed on both front and back surfaces thereof.

Then, inductor conductors 201, 202, 203 are disposed on the first through third layers of the first laminate, respectively, while a capacitor electrode 220 is disposed on the fourth layer of the same. Similarly, the second laminate 160 comprises inductor conductors 211, 212, 213, and a capacitor electrode 220. These inductor conductors 201-203, 211-213, which are strip-shaped electrodes similar to those of the third embodiment, linearly extend in the front-to-back direction (y-axis direction) such that their ends 201a, 202a, 203a expose to the front surface of the first laminate 150 to which the fourth laminate 180 is to be bonded, and the other ends 201b, 202b, 203b expose to the back surface of the first laminate 150 to which the third laminate 170 is bonded (the second laminate 160 also extends in a similar manner).

Also, the odd-numbered layer inductor conductors (the first inductor conductor 201 on the first layer and the third inductor conductor 203 on the third layer) are disposed to lie one on the other, when viewed in plan, while the even-numbered layer inductor conductor (the second inductor conductor 202 on the second layer) is disposed in parallel with and spaced apart from the odd-numbered layer inductor conductors 201, 203 by a fixed interval. Then, these first inductor conductor 201, second inductor conductor 202, and third inductor conductor 203 are interconnected in order through the connection conductors 171, 172 disposed on the surface (front surface) of the third laminate 170 and the connection conductor 181 disposed on the fourth laminate 180, thereby forming a spiral inductor which extends within the first laminate 150 in the vertical direction (z-axis direction) (a spiral inductor is formed in the second laminate 160 as well).

The inductor conductors can be connected with the capacitor electrode in a manner similar to the connection of the inductor conductors to each other. Specifically, the third inductor conductor 203 of the first laminate 150 may be connected with the capacitor electrode 220 through the connection conductor 172 disposed on the surface (front surface) of the third laminate 170, while the third inductor conductor 213 of the second laminate 160 may be connected with the capacitor electrode 220 through the connection conductor 174 disposed on the back surface (rear surface) of the third electrode 170. As appreciated, these capacitor electrodes 220 oppose ground electrodes 221 formed on the top of the first laminate 150 and second laminate 160, respectively, to comprise capacitors C1, C2 of the respective resonators 143, 144.

Further, the first laminate 150 is provided with an input terminal electrode (not shown) in a leading edge area of the bottom thereof, and this input terminal electrode is connected with one end 201a of the first inductor conductor 201 through a throughhole V. Likewise, the second laminate 160 is provided with an output terminal electrode (not shown) in a trailing edge area of the bottom thereof, and this output terminal electrode is connected with the other end 211b of the first inductor conductor 211 through a throughhole V. Further, a ground electrode (not shown) can be formed between these input terminal electrode and output terminal electrode across the respective bottoms of the first laminate 150, third laminate 170, and second laminate 160. This ground electrode can be connected with the ground electrode 221 formed on the top of the first laminate 150 and second laminate 160 through surface electrodes which are formed to extend on side surfaces of the first laminate 150, third laminate 170, and second laminate 160.

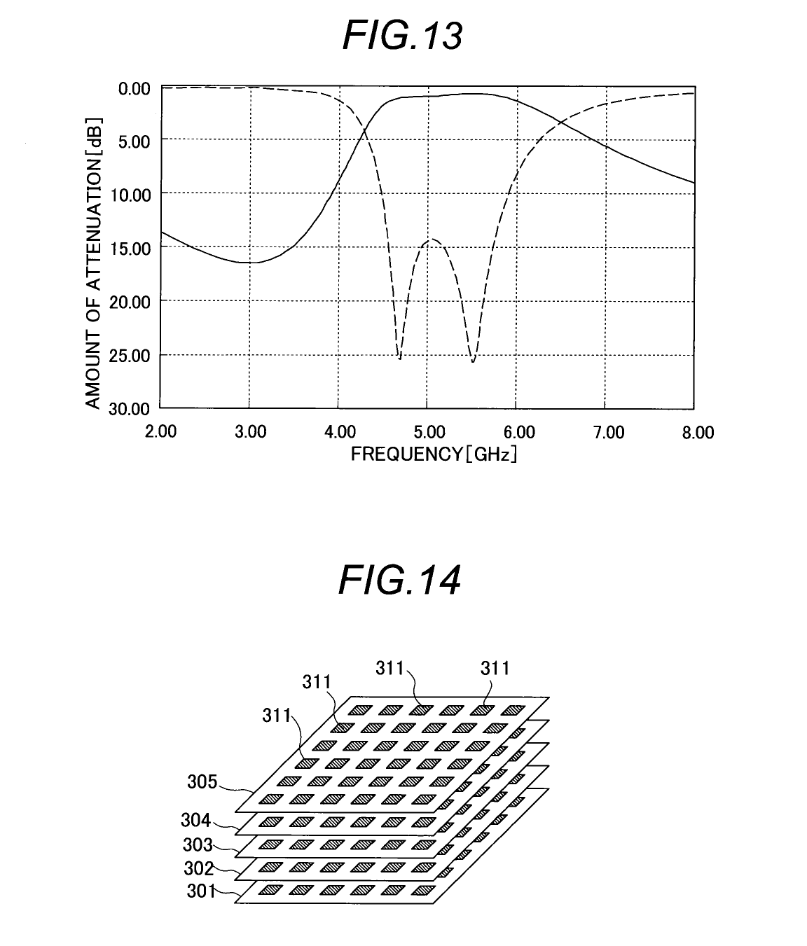

FIG. 13 shows the frequency characteristics of the bandpass filter according to this embodiment, where a solid line represents the pass characteristic, and a broken line represents the shut-off characteristic, respectively. As shown in FIG. 13, according to the bandpass filter of this embodiment, the pass characteristic of approximately 1.0 dB can be accomplished in a 5-GHz band which is one of wireless LAN standards that enable fast transmissions.

### [Manufacturing Method]

A method of manufacturing an electronic device according to the present invention can preferably apply a previous proposition (Japanese Patent Application No. 2010-165398) of the present Applicant, though not so limited. In the following, this method will be described in brief with reference to FIGS. 14 through 27, giving the bandpass filter of the fourth embodiment as an example.

### (1) Fabrication of Laminated Sheet and Laminate Stick:

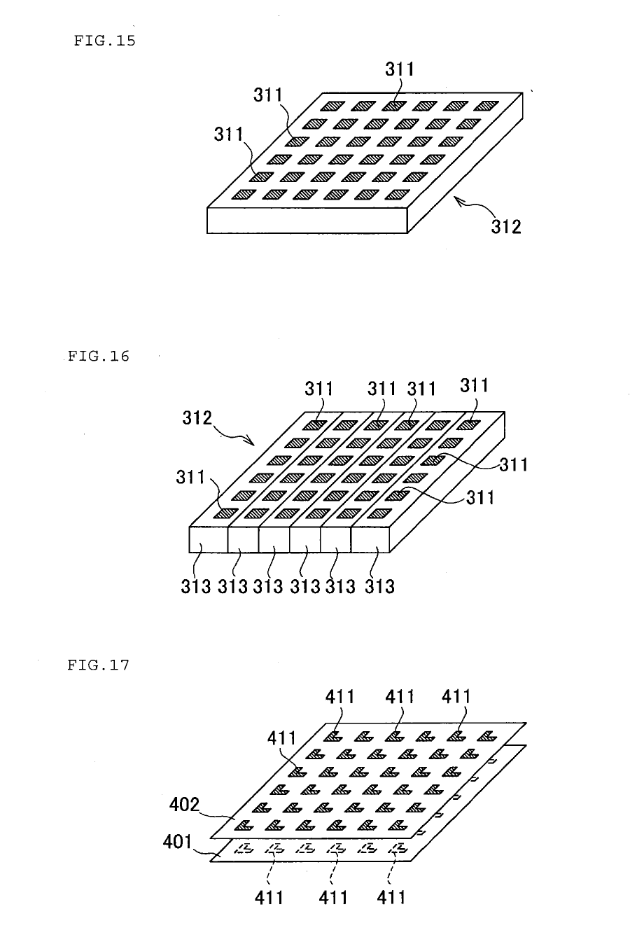

As shown in FIG. 14, first, unsintered green sheets formed of ceramic material are prepared, and a conductive paste is coated on the surfaces thereof, and predetermined conductor patterns are printed on the green sheets, corresponding to the respective wiring layers of the first laminates 150, 160, thereby fabricating ceramic sheets 301, 302, 303, 304, 305. The conductor patterns 311 printed on each of the ceramic sheets 301-305 are formed such that the patterns 311 of a number corresponding to the number of chips to be fabricated are arranged vertically and horizontally in a matrix shape. It should be understood that each conductor pattern 311 shown in FIG. 14 is intended to represent the concept of the manufacturing method, and not to exactly draw the shape of conductors in the embodiment (this is also applied to FIGS. 15 through 27).

Next, the ceramic sheets 301-305 are laid one on another in a predetermined order, while aligned, and thermocompression bonded for integration, resulting in a first laminate 312, as shown in FIG. 15.

Then, as shown in FIG. 16, the first laminate sheet 312 is cut into strips to fabricate first laminate sticks 313. This first laminate stick 313 includes a plurality of sets of laminated conductor patterns, which comprise the first laminate 150, arranged in the longitudinal direction (length-wise direction). As to the second laminate 160, second laminate sticks 323 are fabricated through similar steps, where each stick 323 includes a plurality of sets of conductor patterns, which comprise the second laminate 160, arranged in the longitudinal direction.

A third laminate stick is fabricated in a similar manner. As shown in FIG. 17, unsintered green sheets are prepared, as is the case with the fabrication of the first laminated sheets, and a conductive paste is coated on the surfaces thereof, and predetermined corresponding conductor patterns are printed on the top and bottom of the third laminate 170, thus fabricating ceramic sheets 401, 402. The conductor patterns formed on each of the ceramic sheets 401, 402 are arranged vertically and horizontally in a matrix shape, in a manner similar to the first laminated sheets.

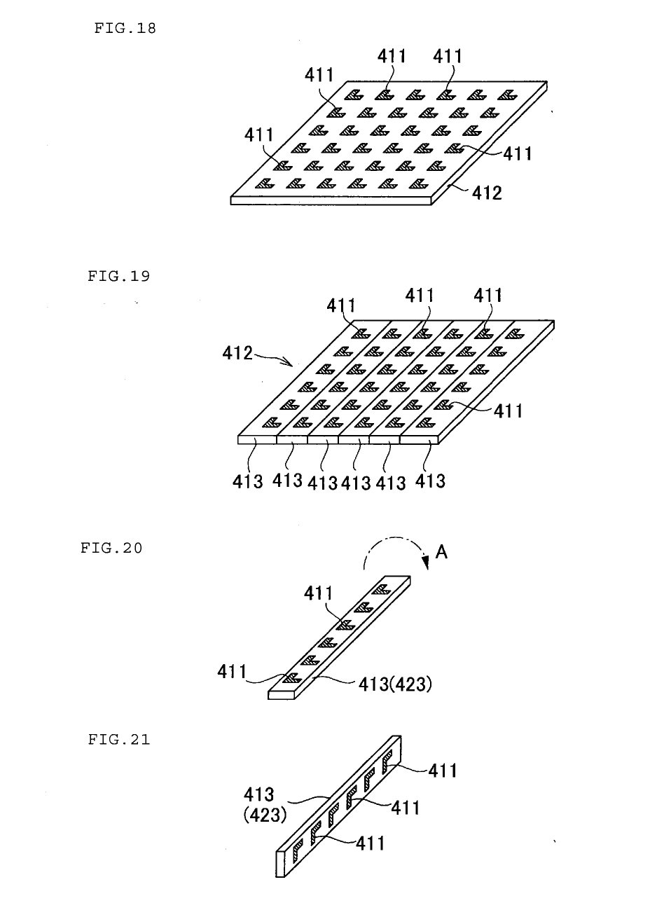

Next, the ceramic sheets 401, 402 are laid one on the other, while aligned, and thermocompression bonded for integration, thereby fabricating a third laminated sheet 412, as shown in FIG. 18. Subsequently, the third laminated sheet 412 is cut into strips to create third laminate sticks 413, as shown in FIG. 19.

As to the fourth laminate 180 and fifth laminate 190, fourth laminate sticks 423 are fabricated through similar steps, where a plurality of sets of conductor patterns 181, 191, which constitute the fourth laminate 180 and fifth laminate 190, respectively, are arranged in the longitudinal direction. This fourth laminate stick is assumed to be formed with a conductor pattern (connection conductor 181) of the fourth laminate 180 on one of the top and bottom surfaces, and with a conductor pattern (connection conductor 191) of the fifth laminate 190 on the other surface.

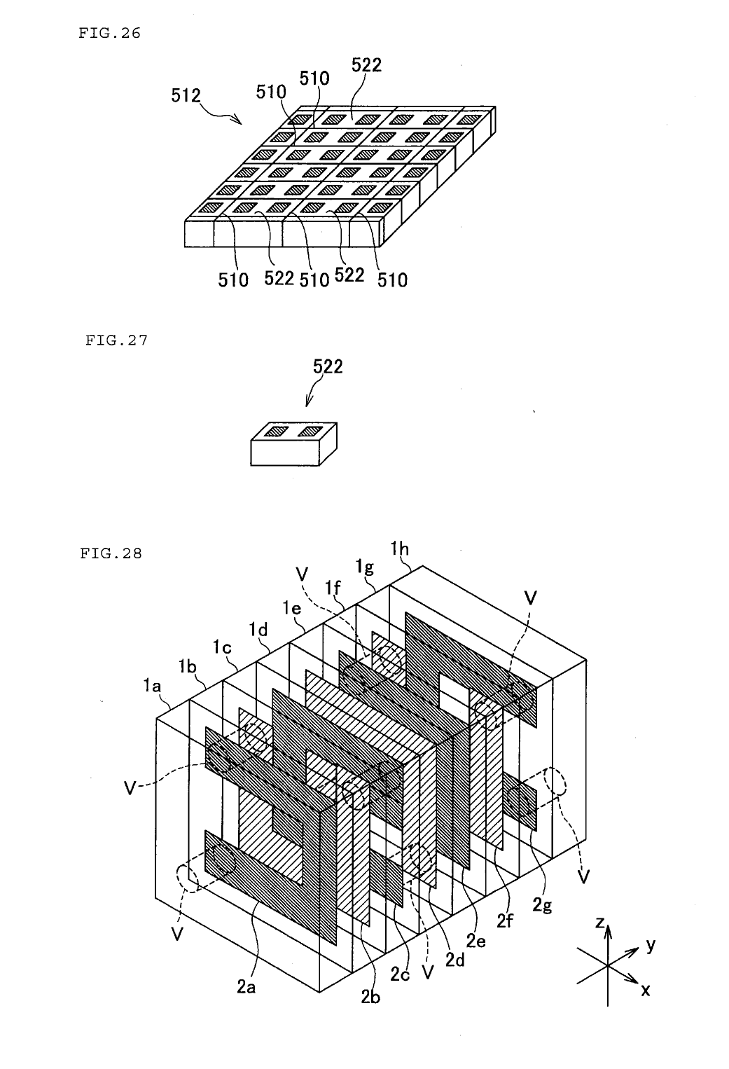

It should be noted that in fabricating the fourth laminate sticks 423, in order to ensure a cutting margin when the fourth laminate sticks 423 are cut in a subsequent singulation step (see a cut line 510 in FIGS. 25 and 26), an additional ceramic sheet may be laminated to be interposed between the ceramic sheet on which the conductor patterns have been formed for the fourth laminate 180 on one side and the ceramic sheet on which the conductor patterns have been formed for the fifth laminate 190 on the other side.

### (2) Reorganization of Laminated Sheets:

As shown in FIGS. 20 and 21, the third laminate stick 413 and fourth laminate stick 423 are rotated by 90° about the longitudinal direction thereof such that their wiring layers (top and bottom surfaces) are upright.

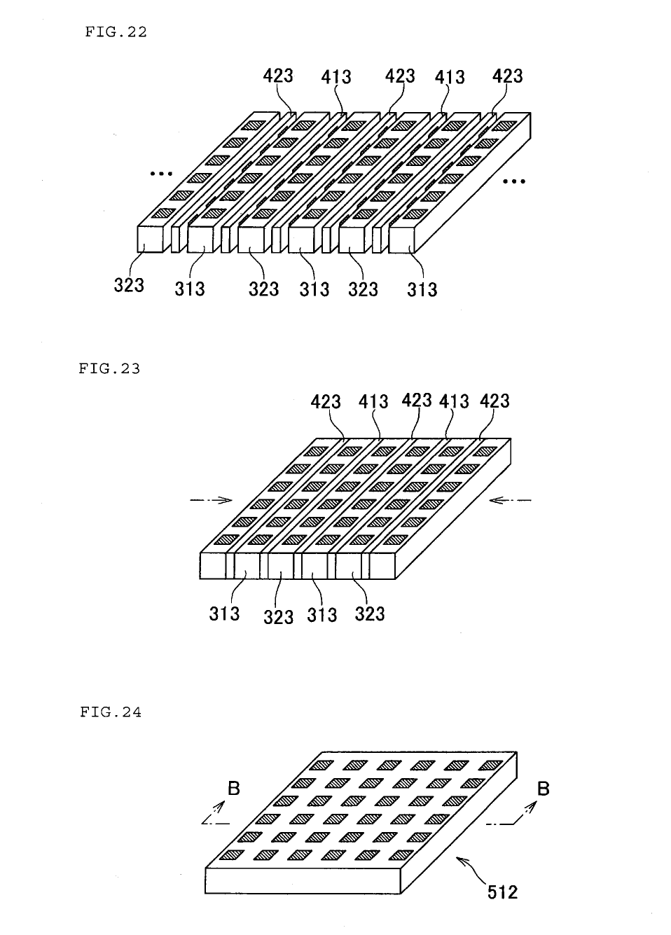

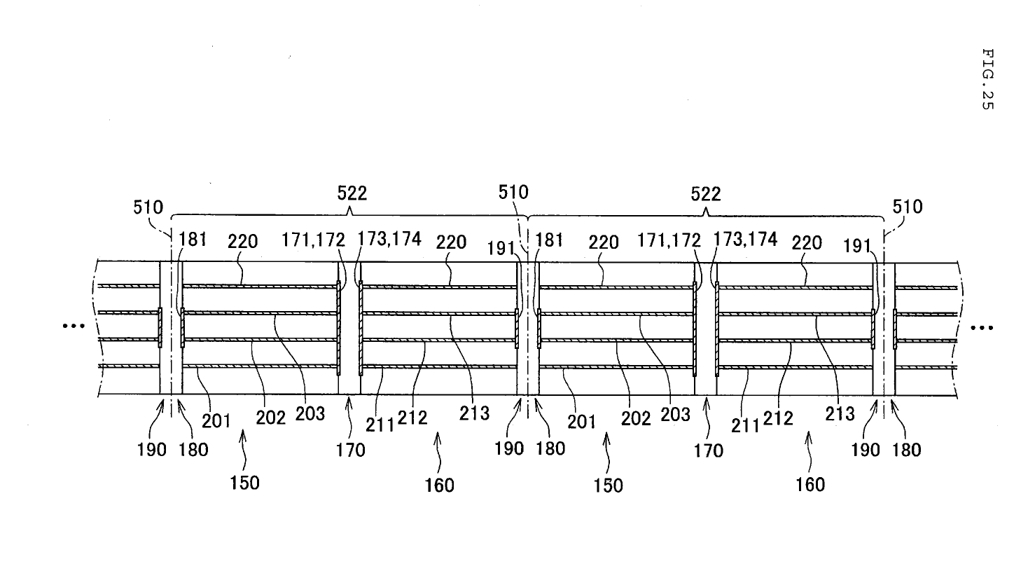

Then, as shown in FIG. 22, the first laminates 313 and second laminates 323 are alternately arranged, and the third laminate stick 413 or fourth laminate stick 423 rotated by 90° is put between the respective first laminate stick 313 and second laminate stick 323. Then, as shown in FIG. 23, these first through fourth laminate sticks 313, 323, 413, 423 are thermocompression bonded for integration. In this way, a reorganized laminated sheets 512 are produced as shown in FIG. 24.

As shown in FIG. 25, this reorganized laminated sheets 512 have the adjoining fourth laminate stick 423 (fourth laminate 180), first laminate stick 313 (first laminate 150), third laminate stick 413 (third laminate 170), and second laminate stick 323 (second laminate 160), and fourth laminate stick 423 (fifth laminate 190) bonded to each other, so that the conductors included in the respective adjoining laminate sticks are electrically connected to each other.

### (3) Singulation and Sintering:

As shown in FIG. 26, the third laminated sheets 512 are cut along cut lines 510 (see FIG. 25 as well) in the vertical and horizontal directions into cubes (dices), to produce chips 522 as shown in FIG. 27. Subsequently, the individual chips 522 are sintered. In this way, the ceramic layers within the first through fifth laminates 150, 160, 170, 180, 190 are sintered to become a single continuously sintered body. As appreciated, after the sintering, external electrodes (terminal electrodes) may be formed as appropriate on the outer surface of the chip 522.

The filter chip of the fourth embodiment can be manufactured in the foregoing manner. According to this manufacturing method, the electronic part according to the present invention can be manufactured with high productivity. As appreciated, the foregoing manufacturing method can be similarly applied to the electronic parts according to the remaining embodiments.

### DESCRIPTION OF REFERENCE NUMERALS

C1, C2 Capacitors
L1, L2 Inductors
V Throughhole
1a, 1b, 1c, 1d, 1e, 1f, 1g, 1h, 11, 12, 13, 14, 15, 16, 17, 101, 102, 103, 104, 105, 106, 107, 108, 109, 151, 152, 153, 154, 155, 161, 162, 163, 164, 165, 301, 302, 303, 304, 305, 401, 402 Ceramic Green Sheets
2a, 2b, 2c, 2d, 2e, 2f, 2g, 21, 22, 23, 24, 25, 26, 61, 62, 63, 64, 65, 66, 67, 68, 69, 70, 111, 112, 113, 114, 115, 116, 117, 201, 202, 203, 211, 212, 213 Inductor Conductors
10, 40, 100, 150 First Laminates
21a, 22a, 23a, 24a, 25a, 26a, 61a, 62a, 63a, 64a, 65a, 66a, 67a, 68a, 69a, 70a, 111a, 112a, 113a, 114a, 115a, 116a, 117a, 201a, 202a, 203a, 211a, 212a, 213a One End of Inductor Conductors
21b, 22b, 23b, 24b, 25b, 26b, 61b, 62b, 63b, 64b, 65b, 66b, 67b, 68b, 69b, 70b, 111b, 112b, 113b, 114b, 115b, 116b, 117b, 201b, 202b, 203b, 211b, 212b, 213b Other Ends of Inductor Conductors
30, 80, 120, 160 Second Laminates
31, 32, 33, 34, 35, 36, 37, 81, 82, 83, 84, 91, 92, 93, 94, 121, 122, 123, 131, 132, 133, 171, 172, 173, 174, 181, 191 Connection Conductors
31a, 32a, 33a, 34a, 35a, 81a, 82a, 83a, 84a, 91a, 92a, 93a, 94a One End of Connection Conductors
31b, 32b, 33b, 34b, 35b, 81b, 82b, 83b, 84b, 91b, 92b, 93b, 94b Other Ends of Connection Conductors
90, 130, 170 Third Laminates
141 Input Terminal
142 Output Terminal
143 First-Stage LC Resonator
144 Second-Stage LC Resonator
180 Fourth Laminate
190 Fifth Laminate
220 Capacitor Electrode
221 Ground Electrode
311, 411 Conductor Patterns
312 First Laminated Sheet
313 First Laminated Stick
323 Second Laminated Stick
412 Third Laminate Sheet
413 Third Laminated Stick
423 Fourth Laminated Stick
510 Cut Line
512 Re-organized Laminated Sheet
522 Filter Chip

1. A laminated electronic part including a coil-shaped inductor, comprising:
a first laminate having two or more wiring layers laminated through an insulating layer; and
a second laminate having at least one insulating layer and a wiring layer formed on a surface of the insulating layer, and bonded to said first laminate,
said laminated electronic part characterized in that:
said wiring layers in said first laminate and said wiring layers in said second laminate are substantially orthogonal to each other,
said first laminate includes:
a first inductor conductor disposed on a first wiring layer of said two or more wiring layers; and
a second inductor conductor disposed on a second wiring layer of said two or more wiring layers, and
said second laminate includes:
a connection conductor for electrically connecting an end of said first inductor conductor with an end of said second inductor conductor on a surface of said second laminate to which said first laminate is bonded, such that said first inductor conductor and said second inductor conductor form a coil-shaped inductor.

2. A laminated electronic part according to claim 1, wherein:
said first laminate has the shape of rectangular parallelepiped as a whole,
said first inductor conductor is formed on said first wiring layer in a loop shape, and has one end and the other end exposed to a surface of said first laminate to which said second laminate is bonded,
said second inductor conductor is formed in a loop shape so as to substantially lie on said first inductor conductor on said second wiring layer, wherein said second inductor conductor has one end exposed to the surface of said first laminate to which said second laminate is bonded, and disposed at a position substantially matching with the one end of said first inductor conductor with respect to a direction in which said wiring layers are laminated in said first laminate, and said second inductor conductor has the other end exposed to a surface of said first laminate to which said second laminate is bonded, and disposed at a position substantially matching with the other end of said first inductor conductor, and
said connection conductor electrically connects the other end of said first inductor conductor with the one end of said second inductor conductor.

3. A laminated electronic part including a coil-shaped inductor, comprising:
a first laminate having four or more wiring layers laminated through an insulating layer and having the shape of rectangular parallelepiped as a whole;
a second laminate including at least one insulating layer, and a wiring layer formed on a surface of said insulating layer, said second lamiane being bonded to said first laminate; and
a third laminate including at least one insulating layer, and a wiring layer formed on a surface of said insulating layer, said third laminate being bonded to said first laminate,
said laminated electronic part characterized in that:
said wiring layer on said second laminate and said wiring layer on said third laminate are both substantially orthogonal to said wiring layers in said first laminate,
said first laminate includes a first bonding surface to which said second laminate is bonded, and a second bonding surface to which said third laminate is bonded, said second bonding surface being opposite to or adjacent to said first bonding surface,
said first laminate includes a first wiring layer, a second wiring layer, a third wiring layer, and a fourth wiring layer from above in order,
said first laminate includes:
a first inductor conductor disposed on the first wiring layer;
a second inductor conductor disposed on the second wiring layer;
a third inductor conductor disposed on the third wiring layer; and
a fourth inductor conductor disposed on the fourth wiring layer,
wherein said first inductor conductor is formed on said first wiring layer in a loop shape, and has one end and the other end thereof both exposed to said first bonding surface,
said second inductor conductor is formed on said second wiring layer in a loop shape such that said second inductor conductor substantially lies on said first inductor conductor, and has one end and the other end thereof both exposed to said second bonding surface,
said third inductor conductor is formed on said third wiring layer in a loop shape such that said third inductor conductor substantially lies on said first inductor conductor and said second inductor conductor, said third inductor conductor has one end thereof exposed to said first bonding surface and disposed at a position substantially matching with one end of said first inductor conductor with respect to a direction in which lamination is made in said first laminate, and said third inductor conductor has the other end exposed to said first bonding surface and disposed at a position substantially matching with the other end of said first inductor conductor with respect to the direction in which the lamination is made in said first laminate, and
said fourth inductor conductor is formed on said fourth wiring layer in a loop shape such that said fourth inductor conductor substantially lies on said first inductor conductor, said second inductor conductor, and said third inductor conductor, and has one end thereof exposed to said second bonding surface and disposed at a position substantially matching with the one end of said second inductor conductor with respect to the direction in which the lamination is made in said first laminate, and the other end thereof exposed to said second bonding surface and disposed at a position substantially matching with the other end of said second inductor conductor with respect to the direction in which the lamination is made in said first laminate,
said second laminate includes a first connection conductor for electrically connecting the other end of said first inductor conductor with the one end of said third inductor conductor on said first bonding surface such that said first inductor conductor and said third inductor conductor form a coil-shaped inductor, and
said third laminate includes a second connection conductor for electrically connecting the other end of said second inductor conductor with the one end of said fourth inductor conductor on said second bonding surface such that said second inductor conductor and said fourth inductor conductor form the coil-shaped inductor.

4. A laminated electronic part including a coil-shaped inductor, comprising:
a first laminate having three or more wiring layers laminated through an insulating layer and having the shape of rectangular parallelepiped as a whole;
a second laminate including at least one insulating layer and a wiring layer formed on said at least one insulating layer, said second laminate being bonded to said first laminate; and
a third laminate including at least one insulating layer and a wiring layer formed on said at least one insulating layer, said third laminate being bonded to said first laminate,
said laminated electronic part characterized in that:
said wiring layer on said second laminate and said wiring layer on said third laminate are both substantially orthogonal to said wiring layers in said first laminate,
said first laminate includes a first bonding surface to which said second laminate is bonded, and a second bonding surface to which said third laminate is bonded, said second bonding surface being opposite to said first bonding surface,
said first laminate includes a first wiring layer, a second wiring layer, and a third wiring layer from above in order,
said first laminate includes:
a first inductor conductor having one end thereof exposed to said first bonding surface and the other end thereof exposed to said second bonding surface, said first inductor conductor being formed on said first wiring layer such that said first inductor conductor extends from said first bonding surface to said second bonding surface;
a second inductor conductor having one end thereof exposed to said first bonding surface and the other end thereof exposed to said second bonding surface, said second inductor conductor being formed on said second wiring layer such that said second inductor conductor extends from said first bonding surface to said second bonding surface; and
a third inductor conductor having one end thereof exposed to said first bonding surface and the other end thereof exposed to said second bonding surface, said third inductor conductor being formed on said third wiring layer such that said third inductor conductor extends from said first bonding surface to said second bonding surface,
wherein said first inductor conductor and said third inductor conductor are disposed to substantially lie on the other when viewed in a direction in which said first lamination is made in said first laminate, and
said first inductor conductor and said second inductor conductor are spaced apart from each other, and said third inductor conductor and said second inductor conductor are spaced apart from each other when viewed in the direction in which the lamination is made in said first laminate,
said second laminate includes a first connection conductor for electrically connecting the one end of said first inductor conductor with the one end of said second inductor conductor on said first bonding surface such that said first inductor conductor and said second inductor conductor form a coil-shaped inductor, and
said third laminate includes a second connection conductor for electrically connecting the other end of said second inductor conductor with the other end of said third inductor conductor on said second bonding surface such that said second inductor conductor and said third inductor conductor form a coil-shaped inductor.

5. A laminated electronic part including a coil-shaped inductor, comprising:
a first laminate having two or more wiring layers laminated through an insulating layer and having the shape of rectangular parallelepiped as a whole;
a second laminate having two or more wiring layers laminated through an insulating layer and having the shape of rectangular parallelepiped as a whole; and
a third laminate having a front wiring layer formed on a front surface thereof and a back wiring layer formed on a back surface thereof and interposed between said first laminate and said second laminate, said third laminate being bonded to said first laminate and to said second laminate, such that said front wiring layer is in contact with said first laminate and said back wiring layer is in contact with said second laminate,
wherein said front wiring layer on said third laminate is substantially orthogonal to said wiring layers in said first laminate, and
said back wiring layer on said third laminate is substantially orthogonal to said wiring layers in said second laminate,
said laminated electronic part characterized in that:
said first laminate includes:
a first inductor conductor disposed on a first wiring layer of said two or more wiring layers in said first laminate; and
a second inductor conductor disposed on a second wiring layer of said two or more wiring layers in said first laminate,
said second laminate includes:
a third inductor conductor disposed on a first wiring layer of said two or more wiring layers in said second laminate; and
a fourth inductor conductor disposed on a second wiring layer of said two or more wiring layers in said second laminate, and
said third laminate includes:
a first connection conductor on said front wiring layer for electrically connecting an end of said first inductor conductor with an end of said second inductor conductor on a surface of said third laminate to which said first laminate is bonded, such that said first inductor conductor and said second inductor conductor form a coil-shaped inductor; and
a second connection conductor on said back wiring layer for electrically connecting an end of said third inductor conductor with an end of said fourth inductor conductor on a surface of said third laminate to which said second laminate is bonded, such that said third inductor conductor and said fourth inductor conductor form a coil-shaped inductor.
